(19) United States
(12) Patent Application Publication
(10) Pub. No.: US 2004/0046672 A1
(43) Pub. Date: Mar. 11, 2004

(54) System for detecting the condition of a container and for transmitting detected data to a central facility

(76) Inventors: John P. Kasik, Dallas, TX (US); Jon J. Kendzie, McKinney, TX (US)

Correspondence Address: Gary M. Cohen, Esq., Strafford Building Number Three, Suite 300, 125 Strafford Avenue, Wayne, PA, 19087-3318, US

(21) Appl. No.: 10/238,752

(22) Filed: Sep. 10, 2002

(51) Int. Cl. G08B 21/00

(52) U.S. Cl. 340/612

(57) ABSTRACT

A signaling device is mated with a conventional container to indicate when the container is ready to be emptied of its contents. The signaling device includes a combination of radio frequency (RF) devices that can detect the condition of a particular container, primarily the level of the contents present in the container, and transmit data pertaining to the condition of the container to a central, data-monitoring facility. The data which is received by the monitoring facility is then used to determine when collections are to take place, and to establish efficient routing for the necessary refuse-collecting personnel and equipment.

### BACKGROUND OF THE INVENTION

The present invention relates primarily to the field of refuse collection, and more particularly, to a system which can operate to monitor the condition of a container, such as a refuse container, and to inform a central facility of the condition of the container so the container can be emptied by a refuse collection service. Although the following discussion is given in the context of refuse collection, it will be appreciated that the following improvements can benefit other industries which use containers for any of a variety of diverse purposes.

In conjunction with the collection of refuse, common practice is to station containers at each of a plurality of sites so that customers of the collection service can deposit refuse in their respective containers for subsequent collection, usually according to a pre-established schedule. The collection service then takes appropriate steps, according to the pre-established schedule, to empty the containers of its customers and to remove the contents for disposal. Some collection services charge a flat fee for the services provided, while others charge according to the number of containers that are emptied.

A common practice for emptying the containers of their contents is to employ a service vehicle which includes a hopper for receiving the contents of the containers, and a lifting mechanism for engaging each of the several containers and for lifting the engaged container to the hopper. In the course of lifting the container to the hopper, steps are taken to invert the container so that its contents fall into the hopper under the influence of gravity. This is often facilitated by providing the lifting mechanism and the container with cooperating structures which enable the operator to perform the desired operations remotely, from the service vehicle.

Such a procedure can be quite efficient since the entire operation can be performed remotely, by a single operator driving the service vehicle. In the course of such operations, however, it was not uncommon for the operator to perform such scheduled operations on empty or partially filled containers. This tended to limit the overall efficiency of the operation, in turn contributing to unnecessary costs (e.g., labor costs, fuel costs, etc.).

To improve overall efficiency, U.S. patent application Ser. No. 09/965,964, filed Sep. 28, 2001, and entitled “System for Auditing Refuse Collection” describes a system for auditing the refuse collection process. To this end, customers are charged for service according to the number of times their refuse containers are accessed. The customers subscribing to the service are in this way motivated to call for collections of their refuse only from containers that are substantially full, or the refuse collection service is compensated for additional container pick-ups.

Such collections can be called for using a device such as is described in U.S. Pat. No. 6,295,946, issued Oct. 2, 2001, and entitled “Signaling Device for Use with a Container”. The disclosed signaling device preferably takes the form of a flag, one end of which is coupled with a hinge associated with the refuse container. The hinged connection allows the flag to move between a lowered position in which the flag lies over the cover of the container, and a raised position in which the flag extends upwardly from the container, developing a change in state which is indicative of access to the container. The signaling device is automatically returned to the lowered position when the container is emptied.

Moving the signaling device to a pre-established position (e.g., a raised position) can then indicate which of the containers are ready to be emptied, and the operator of a service vehicle can then take steps to access and empty the indicated container. In the course of accessing the container, steps are taken, preferably automatically, to identify the customer (e.g., by address) and to store data corresponding to each transaction. The stored data can then be collected and used to charge each customer according to the collection which has been requested, either motivating the customers to call for pick-ups only when their refuse containers are substantially full, or by compensating the refuse collection service for additional container pick-ups.

### SUMMARY OF THE INVENTION

The above-described systems work well to provide an efficient refuse collection operation, or to implement other operations that can benefit from such improvements. However, in accordance with the present invention, an alternative system has been developed which can still further enhance the efficiency of the overall operations being performed.

To this end, each of the various containers are fitted with a state-detecting system, which is preferably implemented with a combination of radio frequency (RF) devices that can both detect the condition (or state) of a particular container and transmit (or retransmit) data pertaining to the condition of the container to a central, data-monitoring facility. The data which is received by the monitoring facility is then used to determine when collections are to take place, and to establish efficient routing for the necessary refuse-collecting personnel and equipment.

The system is preferably implemented with two elements. A first element is a short range radio frequency (RF) transmitter which is capable of detecting the level of refuse in a particular container, i.e., the content level of the container. If the content level (the state) of the container meets a set level which indicates that the contents of the container are then ready for collection, a second element is activated to signal the central, monitoring facility for a pick-up. The second element is a long range radio frequency (RF) transmitter which is capable of transmitting a signal to the central, monitoring facility. A series of radio frequency (RF) receivers can be strategically placed to establish an adequate operating range from one of the transmitters to one of the receivers, i.e., over a distance of approximately 25 km (i.e., 16 miles). Received signals can then be retransmitted from the plurality of RF receivers to the central, monitoring facility, for subsequent use, as desired.

For further detail regarding preferred implementations of the present invention, reference is made to the detailed description which is provided below, taken in conjunction with the following illustrations.

### BRIEF DESCRIPTION OF THE DRAWINGS

FIG. 1 is a schematic cross-sectional view of a container which has been provided with a state-detecting device in accordance with the present invention.

FIG. 2 is a schematic plan view illustrating the transmission of data produced by the state-detecting device of FIG. 1 to an intermediate, data-receiving grid.

FIG. 3 is a schematic plan view illustrating the transmission of data received by the intermediate, data-receiving grid to a central monitoring facility.

### DETAILED DESCRIPTION OF THE INVENTION

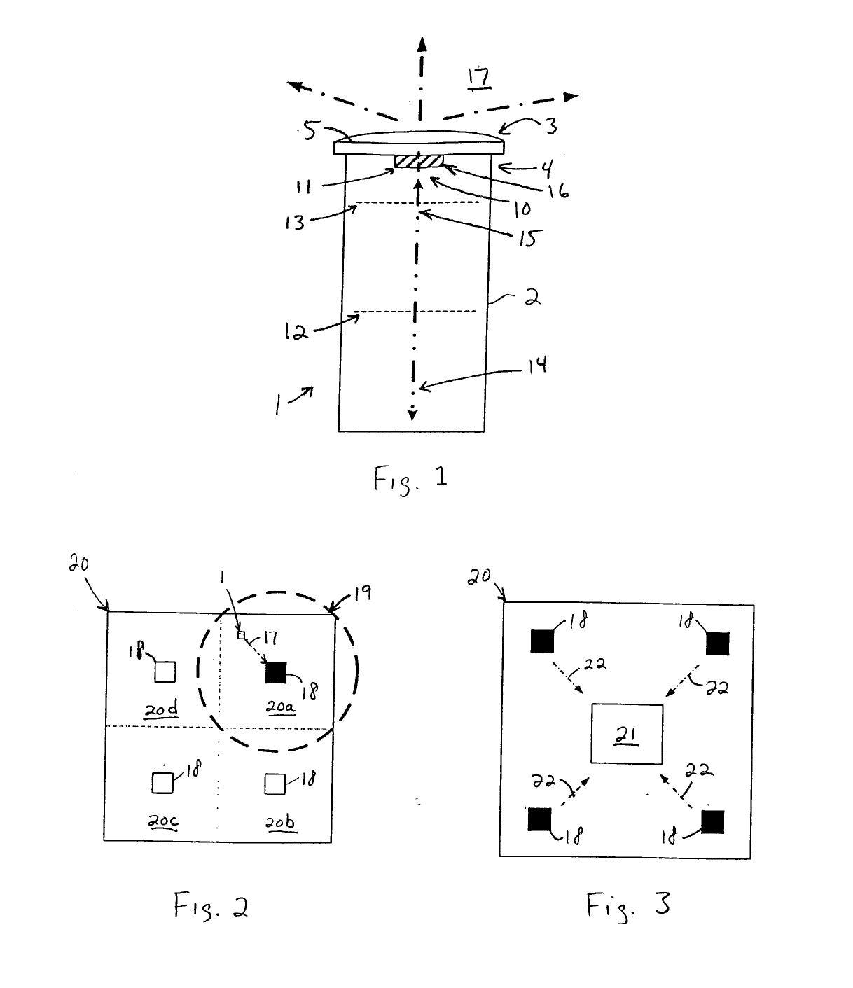

FIG. 1 shows a container 1 which has been fitted with a signaling assembly 10 produced in accordance with the present invention. It will be understood that the container 1 shown in FIG. 1 is a schematic representation of any of a variety of different types of containers that can be used for containing refuse which is to be collected by a servicing agency. It is also to be understood that a refuse container has been selected only for purposes of illustration, and that the improvements of the present invention can similarly be used with any of a variety of different types of containers, which can be used for purposes other than refuse collection. Although the description which follows discusses the application of the improvements of the present invention to refuse containers, and refuse collection operations, it is further to be understood that the improvements of the present invention can be used with other types of systems for containing articles, and for servicing such containers or their contents.

The container 1 shown in FIG. 1 is itself entirely conventional, and generally includes a body 2 for receiving contents through an opening 3 defined in upper portions 4 of the container body 2, and a cover 5 for enclosing the opening 3 so that contents of the container are appropriately secured within the container 1. The cover 5 can be loosely fit over the body 2 of the container, but is preferably connected to the body 2 of the container 1, for example, by a hinged connection, primarily for purposes of security and to avoid loss of the cover 5 (and the signaling assembly to be described below).

In accordance with the present invention, the container 1 is fitted with a signaling assembly 10. The signaling assembly 10 is preferably operatively coupled with the cover 5, and is preferably positioned toward the center of the cover 5, as shown, although other placements are also possible. For example, the signaling assembly 5 could be coupled with the body 2 of the container 1, if desired, preferably along the upper portions 4 of the container body 2. However, such placement is presently considered less preferred to avoid potential interference between the signaling assembly 10 and the contents of the container 1.

The signaling assembly 10 includes a first device 11 which is capable of detecting the level of the contents present in the container 1. Any of a variety of devices can be used for this, including both mechanical and electrical level detecting devices. A short range radio frequency (RF) transmitter, such as a crystal-operated, radio transmitter, is preferably used as the data telemetry device for detecting the level of contents present in the container 1. Such devices are themselves known, and are available from any of a number of sources.

The level-detecting device 11 is then calibrated for various depth levels, in otherwise known fashion. For example, the container 1 shown in FIG. 1 (shown with the cover 5 in the closed position) has been calibrated for plural telemetry levels including a level 12 which corresponds to a container 1 that is approximately half full, and a level 13 which corresponds to a container 1 that is considered full.

The cover 5 of the container 1 is then provided with a signaling assembly 10 which includes the level-detecting device 11 (i.e., a crystal (RF) radio transmitter) and which is capable of producing a relatively low level, radio frequency pulse (shown schematically at 14). A corresponding receiver is associated with the transmitter, for receiving signals (shown schematically at 15) which are returned (i.e., reflected) by the contents then present in the container 1. The device 11 is preferably made adjustable, and is calibrated to detect the level 12, 13 of the contents in the container 1 responsive to reflection of the radio frequency pulse 14.

The low level pulses 14 produced by the device 11 are preferably emitted at configurable intervals (for example, every 3 hours), which can be varied to suit a particular application. Such a device can be powered with a low power battery source, which can provide a useful life on the order of five years. As an alternative, free following electromagnetic waves can be used to charge an accumulator to, in turn, generate the low level radio pulses 14.

When the level-detecting device 11 determines that the container has been filled to a specified point, for example, to the level 13, a signal is provided to activate a second device 16 associated with the signaling assembly 10 which is capable of transmitting a long range radio frequency pulse 17 to a remotely located receiver (to be described more fully below). Again, any of a variety of signal transmitting devices, which are themselves known and available from any of a number of sources, can be used for this.

The long range (RF) pulse 17 preferably incorporates an encoded signature which can uniquely identify the container 1 which is then transmitting the long range (RF) pulse, and which is signaling that it is ready for a pick-up. The device 16 for producing the long range (RF) pulse 17 is preferably powered by a low power battery source, which can again provide a useful life on the order of five years.

Referring to FIG. 2, the long range (RF) pulse 17 which is transmitted from a container to be emptied (i.e., the container 1) is transmitted to a remotely located receiver 18. RF pulses of this general type are typically stable for a maximum distance on the order of 25 km. Consequently, for service areas that lie within a radius, shown at 19, which is less than the maximum distance permitted for receiving a stable signal, a single receiver 18 can be used to service all of the containers to be monitored.

Many systems will encompass a service area of a size in excess of the maximum stable range of the long range (RF) pulses 17 which are transmitted from the containers to be emptied, and in such cases, it will be necessary to deploy plural receivers 18 to develop a grid layout that can effectively receive signals 17 from all of the containers which are to be serviced.

As an example, FIG. 2 illustrates a grid layout 20 for a region on the order of 2,500 square kilometers (i.e., a typical city). The grid 20 includes four equally sized cells 20a, 20b, 20c, 20d on the order of 25 km×25 km each. A receiver 18 is centrally placed in each of the cells 20a, 20b, 20c, 20d, ensuring that none of the containers to be serviced exceeds the maximum distance (radius) for the RF pulses 17 being produced by the various signaling assemblies 10 in the system's coverage area. The grid 20 is freely scalable, to any size, by expanding the number of cells (for additional coverage), or by increasing the range of the transmitters 16 associated with the containers (for additional coverage) or the receivers 18 associated with the cells 20a, 20b, 20c, 20d.

Each of the receivers 18 is preferably implemented as a “smart” device, which is capable of receiving the various signals 17 being produced and which can detect the unique pulse signature assigned to a received signal 17. If the receiver 18 receives a signal 17 having a valid signature (e.g., by checking against a resident database of customer signatures), the received signal 17 is preferably amplified, encoded with an additional signature which identifies the intervening receiver 18, and retransmitted to a central monitoring facility (to be described below). Each of the receivers 18 is preferably powered by a permanent, AC power source, and is preferably constructed to industrial standards for purposes of durability.

Referring to FIG. 3, a central facility 21 (e.g., a waste management facility) is provided for monitoring activity occurring in the defined grid 20. The central facility 21 can either be located within the defined grid 20, as shown, or can be remote from the defined grid 20, and is placed in communication with each of the receivers 18 associated with the grid 20 being serviced. Such communication can be accomplished using either wired, or wireless connections, using communications equipment which is otherwise known and available in the industry.

In this way, signals 17 from the containers being serviced are received by the appropriate receiver 18, and are retransmitted to the central facility 21 (shown schematically at 22). The central facility 21 then decodes the received data, which is unique to an identified container 1, and the received information is stored in a database, preferably on a local server. The stored data can then be used to determine the service that is needed, establish routing, and dispatch the appropriate personnel and equipment.

Upon dispatch of the appropriate personnel and equipment, a system for auditing (i.e., tracking) the operations associated with the scheduled collection can be employed, such as the auditing procedures disclosed in U.S. patent application Ser. No. 09/965,964, filed Sep. 28, 2001, and entitled “System for Auditing Refuse Collection”, the subject matter of which is incorporated by reference as if fully set forth herein. In conjunction with operations of the auditing system, the container which is being emptied is preferably identified as part of the refuse collection process. This can be done using electronic devices such as an RF transmitter or an RFID tag, among others. The signaling assembly of the present invention can be combined with such devices (e.g., as a single chip or module) or can be implemented as a separate device, as desired.

It will be understood that various changes in the details, materials and arrangement of parts which have been herein described and illustrated in order to explain the nature of this invention may be made by those skilled in the art within the principle and scope of the invention as expressed in the following claims.

What is claimed is:

1. An apparatus for detecting the condition of a container for receiving contents therein, comprising:
a detector operatively associated with the container, wherein the contents fill the container to an established level, and wherein the detector operates to detect established levels of the contents which correspond to a prescribed level; and
a transmitter coupled with the detector, wherein the transmitter transmits a signal to a remotely located receiver when the detector detects that the established level of the contents in the container corresponds to the prescribed level.

2. The apparatus of claim 1 wherein the detector is a mechanical detector for detecting when the established level of the contents in the container corresponds to the prescribed level.

3. The apparatus of claim 1 wherein the detector is an electrical detector for detecting when the established level of the contents in the container corresponds to the prescribed level.

4. The apparatus of claim 3 wherein the detector includes a radio frequency (RF) transmitter.

5. The apparatus of claim 4 wherein the radio frequency (RF) transmitter is a crystal-operated transmitter.

6. The apparatus of claim 4 wherein the detector further includes a radio frequency (RF) receiver coupled with the radio frequency (RF) transmitter.

7. The apparatus of claim 6 wherein the radio frequency (RF) receiver cooperates with the radio frequency (RF) transmitter to detect the established level of the contents in the container.

8. The apparatus of claim 7 wherein the established level of the contents in the container which corresponds to the prescribed level is a level corresponding to a full container.

9. The apparatus of claim 8 wherein the container is a refuse collecting container having a body enclosed by a cover.

10. The apparatus of claim 9 wherein the detector is coupled with the cover of the container.

11. The apparatus of claim 10 wherein the detector is substantially centrally positioned on an inside surface of the cover.

12. The apparatus of claim 3 wherein the transmitter coupled with the detector is a radio frequency (RF) transmitter.

13. The apparatus of claim 12 wherein the transmitter coupled with the detector transmits a signal including a unique identification signature.

14. The apparatus of claim 12 wherein the transmitter coupled with the detector transmits a signal to a remotely located receiver.

15. The apparatus of claim 14 wherein the remotely located receiver is located at a central monitoring facility.

16. The apparatus of claim 14 wherein the remotely located receiver is one of a plurality of receivers deployed in an established grid pattern.

17. The apparatus of claim 16 wherein the plurality of receivers communicate with a central monitoring facility.

18. The apparatus of claim 17 wherein each of the plurality of receivers transmits a signal including a unique identification signature.

19. The apparatus of claim 1 wherein the apparatus operates to poll the container and determine the established level of the contents in the container on a periodic basis.

20. The apparatus of claim 1 wherein the apparatus for detecting the condition of the container is operatively coupled with a system for auditing a process for collecting the contents from the container using a service vehicle for emptying the contents from the container into a hopper associated with the service vehicle, for receiving the contents in the hopper, wherein the detecting apparatus provides a change in state from a first state signaling that collection is not to be performed to a second state signaling that collection is to be performed, for signaling that the contents of the container are to be collected.

21. The apparatus of claim 20 wherein the detecting apparatus further includes means for identifying the container having the contents to be collected.

22. A method for detecting the condition of a container for receiving contents therein, wherein the contents fill the container to an established level, comprising the steps of:
detecting established levels of the contents which correspond to a prescribed level by operating a level detector coupled with the container; and
transmitting a signal to a remotely located receiver, by operating a transmitter coupled with the detector, when the detector detects that the established level of the contents in the container corresponds to the prescribed level.

23. The method of claim 22 which further includes the step of operating the detector using a radio frequency (RF) signal.

24. The method of claim 23 wherein the radio frequency (RF) signal detects the established level of the contents in the container.

25. The method of claim 24 wherein the established level of the contents in the container which corresponds to the prescribed level is a level corresponding to a full container.

26. The method of claim 23 which further includes the step of operating the transmitter using a radio frequency (RF) signal.

27. The method of claim 26 which further includes the step of transmitting a signal using the transmitter which includes a unique identification signature.

28. The method of claim 26 which further includes the step of transmitting the signal to a remotely located receiver.

29. The method of claim 28 wherein the remotely located receiver is located at a central monitoring facility.

30. The method of claim 28 which further includes the step of deploying a plurality of receivers in an established grid pattern.

31. The method of claim 30 wherein the plurality of receivers communicate with a central monitoring facility.

32. The method of claim 31 which further includes the step of transmitting a signal to the central monitoring facility using one of the plurality of receivers which includes a unique identification signature.

33. The method of claim 22 which further includes the steps of polling the container and determining the established level of the contents in the container on a periodic basis.

34. The method of claim 22 which further includes the step of auditing a process for collecting the contents from the container using a service vehicle for emptying the contents from the container into a hopper associated with the service vehicle, for receiving the contents in the hopper, wherein the detecting provides a change in state from a first state signaling that collection is not to be performed to a second state signaling that collection is to be performed, signaling that the contents of the container are to be collected.
